(19) United States
(12) Patent Application Publication
(10) Pub. No.: US 2026/0367102 A1
(43) Pub. Date: Nov. 19, 2026

(54) SPECIMEN TESTING METHOD, SPECIMEN TESTING DEVICE, AND MEDIUM

(71) Applicant: CANON KABUSHIKI KAISHA, Tokyo (JP)

(72) Inventors: AKIRA YAMAMOTO, Saitama (JP); MAKOTO KAWAGUCHI, Kanagawa (JP); HIDEKI KATO, Tokyo (JP); TAKESHI YAMAUCHI, Tochigi (JP)

(21) Appl. No.: 19/630,638

(22) Filed: Mar. 27, 2026

(30) Foreign Application Priority Data
Mar. 31, 2025 (JP) 2025-058642
Mar. 12, 2026 (JP) 2026-040217

(51) Int. Cl. G01N 35/00; G01N 21/17; G01N 21/31; G01N 21/77

(52) U.S. Cl. CPC G01N 35/00663; G01N 21/31; G01N 21/77; G01N 35/00693; G01N 2021/1765; G01N 2021/3188; G01N 2021/7783; G01N 2035/00534; G01N 2035/00673; G01N 2201/0461; G01N 2201/0636; G01N 2201/12746

(57) ABSTRACT

Provided is a specimen testing method with which an abnormality in a specimen can be suitably detected in a specimen test. The specimen testing method includes: imaging a specimen; dividing an image of the specimen into a plurality of regions; and acquiring, based on pixel values of the divided regions, information on an abnormality in the pixel values of the divided regions.

### BACKGROUND

### Field of the Technology

The present disclosure relates to a specimen testing method, a specimen testing device, and a medium.

### Description of the Related Art

There has been known an automated analysis device which uses a chemical reaction with a test reagent to optically measure the concentration, activity value, or the like of a component contained in a specimen such as blood and urine. The automated analysis device dispenses the specimen and the test reagent into a reaction vessel, measures optical data such as an absorbance, and calculates the concentration of the component to be measured. Typically, the measurement of, for example, the absorbance is performed by using one measuring device per specimen, and hence the absorbance measurement may be a bottleneck in measurement, which may hinder improvement in throughput. One method of solving this issue is to use a plurality of reaction disks, as described in Japanese Patent Laid-Open No. 2010-145377. Another method of improving throughput has also been proposed, as described in International Publication No. WO2004/086010, in which a plurality of specimens are lined up, and absorbance is measured by imaging all of the specimens.

At the time of analyzing a specimen based on, for example, an absorbance, there may be, for example, cases in which foreign matter (for example, air bubble or solid matter) has contaminated the specimen, preventing absorbance from being accurately detected, which may lead to a test error. The methods as disclosed in Japanese Patent Laid-Open No. 2010-145377 and International Publication No. WO 2004/086010 do not particularly take into consideration such an abnormality in the specimen.

### SUMMARY

The present disclosure has been made in view of the above-mentioned circumstances, and is directed to providing a specimen testing method and a specimen testing device with which an abnormality in a specimen can be suitably detected in a specimen test, and a medium for storing a program for causing a computer or the like to execute such a specimen testing method.

In order to achieve the above-mentioned provision, according to one aspect of the present disclosure, there is provided a specimen testing method including: imaging a specimen; dividing an image of the specimen into a plurality of regions; and acquiring, based on pixel values of the plurality of divided regions, information on an abnormality in the pixel values of the plurality of divided regions.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram for schematically illustrating an overall configuration of a specimen testing device according to a first embodiment of the present disclosure.

FIG. 1B is a block diagram for illustrating an example of a functional configuration of a control unit of the specimen testing device.

FIG. 2 is an explanatory diagram for illustrating image division of a cell array to be used in the first embodiment.

FIG. 3 is a graph for showing an absorbance time course for each region in a certain specimen in the first embodiment.

FIG. 4 is a flowchart of processing for calculating a specimen concentration in the first embodiment.

FIG. 5 is a diagram for schematically illustrating an overall configuration of a specimen testing system including a specimen testing device according to a second embodiment of the present disclosure.

FIG. 6 is a diagram for illustrating an image capturing optical system in the second embodiment.

FIG. 7 is an explanatory diagram for illustrating the structure of a filter turret in the second embodiment.

FIG. 8 is an explanatory diagram for illustrating image division of a specimen to be used in the second embodiment.

FIG. 9 is a graph for showing an absorbance time course for each region in a certain specimen in the second embodiment.

FIG. 10 is an explanatory graph for showing a method of detecting an abnormality in a third embodiment of the present disclosure.

FIG. 11 is an explanatory diagram for illustrating a fourth embodiment of the present disclosure, in which movement of foreign matter is illustrated.

FIG. 12 is an explanatory graph for showing a method of detecting an abnormal region in the fourth embodiment.

FIG. 13 is a diagram for illustrating image division of a specimen to be used in a fifth embodiment.

FIG. 14 is an explanatory graph for showing a method of detecting an abnormal region in the fifth embodiment.

### DESCRIPTION OF THE EMBODIMENTS

Now, exemplary embodiments are described in detail with reference to the drawings. In the following description, common components throughout the plurality of drawings are denoted by common reference symbols. Accordingly, common components are described with reference to the plurality of drawings mutually, and description of the components denoted by the common reference symbols is omitted as appropriate. Further, dimensions, materials, shapes, relative positions of the components, and the like illustrated in the following embodiments may be freely selected, and can be changed in accordance with various conditions or a configuration of a device to which the present disclosure is applied.

### First Embodiment

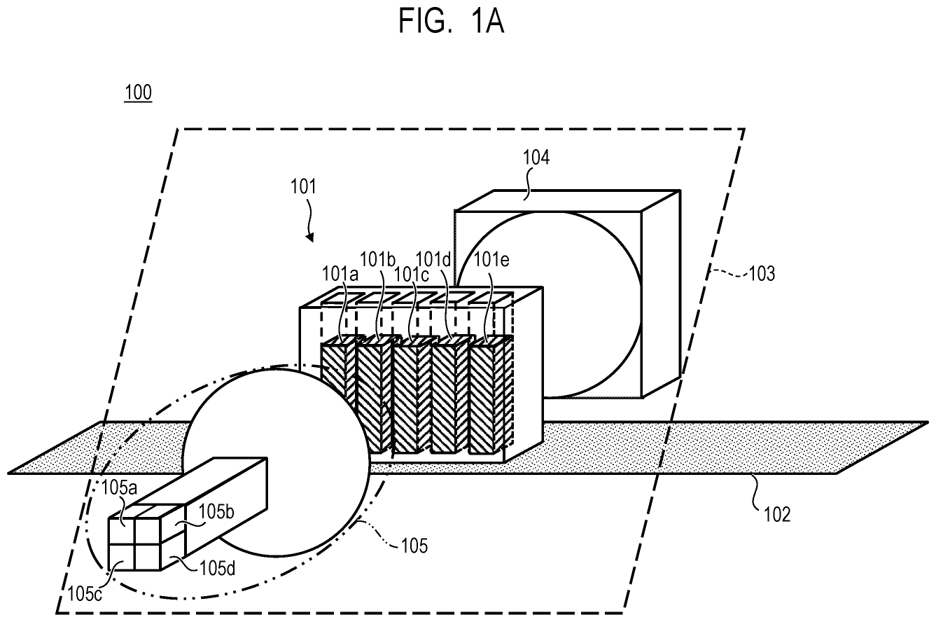

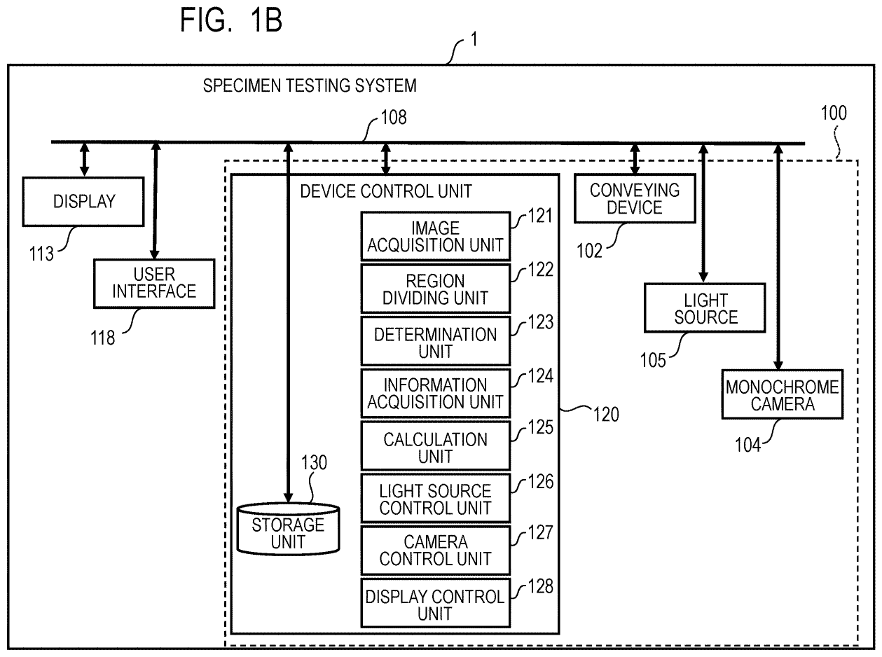

A specimen testing device according to a first embodiment of the present disclosure is now described with reference to FIG. 1A to FIG. 4. FIG. 1A is a diagram for schematically illustrating an overall configuration of a specimen testing device 100 according to the first embodiment. In FIG. 1A, only the components relating to a specimen test are shown, and other components that are arranged in conjunction with the testing device during the specimen test, such as the components for dispensing, stirring, and the like, are not shown.

The specimen testing device 100 according to this embodiment includes a photometry unit 103 and a conveying device 102. A cell array 101 into which test objects, which are a mixture of a specimen and a specimen testing reagent, have been dispensed is placed on the conveying device 102 and conveyed to the photometry unit 103. In the cell array 101, a plurality of specimens are arranged in a row. For example, in the cell array 101 illustrated in FIG. 1A, four specimens (101a to 101d) each taken from a different person and water (101e) for obtaining a reference pixel value during image pickup (which can also be referred to as “imaging”) are dispensed into different cells.

The photometry unit 103 to be used in this embodiment includes a monochrome camera 104 and a light source 105. In this embodiment, the light source 105 includes a plurality of light-emitting diodes (LEDs) 105a to 105d, and each of the plurality of LEDs has an emission band in a different wavelength band. The monochrome camera 104 is arranged so as to pick up light emitted from the light source 105 and transmitted through the cell array 101. The cell array 101 is conveyed to the photometry unit 103 by the conveying device 102, and a transmission image is picked up by the monochrome camera 104 using the light emitted from the light source 105. The transmission image is picked up by the monochrome camera 104 in synchronization with the emission of light by the light source 105.

Next, a specimen testing system 1 in this embodiment is described with reference to FIG. 1B. FIG. 1B is a block diagram for illustrating a functional configuration of the specimen testing system 1. A device control unit 120 in the specimen testing device 100 described with reference to FIG. 1A is connected to the conveying device 102, the light source 105, and the monochrome camera 104 via a bus 108, and is capable of executing the above-mentioned image-pickup operation. Further, the device control unit 120 is also connected to a display 113 and a user interface 118 via the bus 108. The display 113 can be used, for example, to display and present test results to the operator or to notify the operator of a specimen abnormality, which is described later. The user interface 118 can be used to input, for example, image-pickup conditions and information on the test objects. The display 113 and the user interface 118 may be configured in an integrated manner.

The device control unit 120 includes an image acquisition unit 121, a region dividing unit 122, a determination unit 123, an information acquisition unit 124, a calculation unit 125, a light source control unit 126, a camera control unit 127, a display control unit 128, and a storage unit 130. The image acquisition unit 121 acquires the image picked up by the monochrome camera 104. The region dividing unit 122 divides the image of the specimen acquired by the image acquisition unit 121 into a plurality of regions in accordance with a condition described later. Each of the divided regions includes a plurality of pixels from the picked-up image. The determination unit 123 uses the pixel values of the divided regions to determine whether or not the specimen exhibits an abnormal value in each region during testing. The information acquisition unit 124 acquires information on an abnormality in the pixel values of the divided regions based on the result obtained by the determination unit 123. Further, the information acquisition unit 124 selects, from all the divided regions, regions having the pixel values to be used for testing of the specimen based on the acquired information on an abnormality. The calculation unit 125 calculates a test value by using the pixel values of the regions selected by the information acquisition unit 124. For example, in this embodiment, the absorbance of the specimen is calculated as the test value.

The light source control unit 126 controls the light source 105. The camera control unit 127 controls the monochrome camera 104 and can cause, by working together with the light source control unit 126, the monochrome camera 104 to execute image pickup with an exposure time corresponding to the LEDs that are emitting light. The display control unit 128 can display the test result on the display 113. Further, as described later, when, for example, a region indicating an abnormality is included in the image of the specimen, the display control unit 128 can notify the operator of this by displaying the fact that there is a region indicating an abnormality on, for example, the display 113. The manner of notifying the operator is not limited to displaying on the display 113, and may be performed by using a sound emitted from a connected device that emits sound. Details of the specimen testing method executed by the device control unit 120 are described later. The storage unit 130 can store programs or the like relating to operation of the specimen testing device 100 or relating to the specimen testing method executed by the device control unit 120, as well as reference time courses or the like to be used for comparing time courses, which are described later. Although the example in which the above-mentioned components are all arranged together in the device control unit 120 has been described herein, those components may also be provided separately from the device control unit 120. Further, the components from the image acquisition unit 121 to the calculation unit 125 may be provided independently as an image processing device. In addition, such an image processing device may be connected to a plurality of specimen testing devices via the bus 108, and may collectively process images obtained from the plurality of specimen testing devices.

When LEDs having different wavelength bands are used to emit light, differences also arise in the power and emission angle of the light emitted from the LEDs. Further, the sensitivity of the monochrome camera 104 also differs depending on the wavelength. Accordingly, it is preferred to adjust the exposure time at the start of image pickup. Specifically, it is preferred to adjust the exposure time so that the pixel values of the transmission image of water are close to the maximum value of the camera (for example, about 250 for 8-bit output, or about 65,000 for 16-bit output) based on the emission power of the LEDs and the sensitivity of the monochrome camera 104. The adjusted exposure time may be set in the camera control unit 127, or the exposure time for each wavelength may be stored in the storage unit 130 until the operator readjusts the exposure time or until the device is shut down and started up again.

The LEDs (105a to 105d) in the light source 105 emit light having different wavelength bands depending on the measurement. The wavelength bandwidth of an LED is usually from about 10 nm to about 40 nm at FWHM, and the light source control unit 126 changes the LED to emit light to match the measurement wavelength designated for each reagent.

For example, in a case in which glucose measurement is to be performed, first, the LED 105a, which emits light having a wavelength of 505 nm, is caused to emit light, and the cell array 101 through which this light passes is imaged by the monochrome camera 104. Next, the LED 105a is turned off, and the LED 105b, which emits light having another wavelength of 600 nm, is caused to emit light, and the cell array 101 is imaged in the same manner. As a result, images of the cell array 101 are picked up for two wavelengths, and thus data for the two wavelengths used to measure the absorbance of glucose is obtained. In this way, with the wavelength or number of wavelengths to be used for measurement being changed depending on the reagent, image data for the required wavelengths can be obtained. In this embodiment, the configuration using the four LEDs 105a to 105d is taken as an example, but in the present disclosure, it is desired to prepare the number of LEDs that matches the number of wavelengths required for the specimen/reagent.

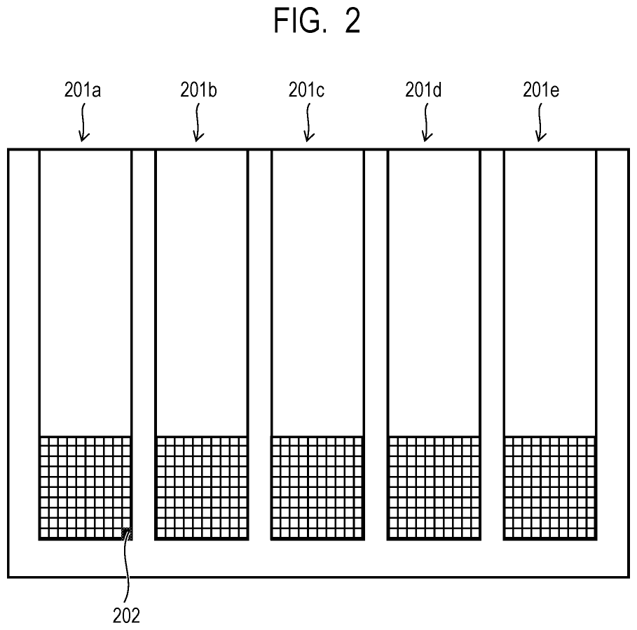

Here, an example of the picked-up transmission image of the cell array 101 is illustrated in FIG. 2. As illustrated in FIG. 2, images of the specimens 101a to 101d and the water 101e dispensed into the cell array are obtained as images 201a to 201d and an image 201e, respectively. In this embodiment, as illustrated in FIG. 2, the images 201a to 201e of the specimens 101a to 101d and the water 101e are each divided into a plurality of regions.

Images used to calculate, for example, an absorbance contain a large number of noise components, and thus it is desired to use images that have been subjected to noise reduction using a plurality of pixel values, such as an average value. For this reason, although the size of the divided regions depends on the size of the specimen being imaged, it is desired that one region be composed of at least 10 pixels or more. Further, it is desired that one region be composed of 100 pixels or more, when possible. In the example of FIG. 2, one region after division is composed of 100 pixels of 10×10 pixels, and the image of one cell is divided into a total of 100 regions of 10×10.

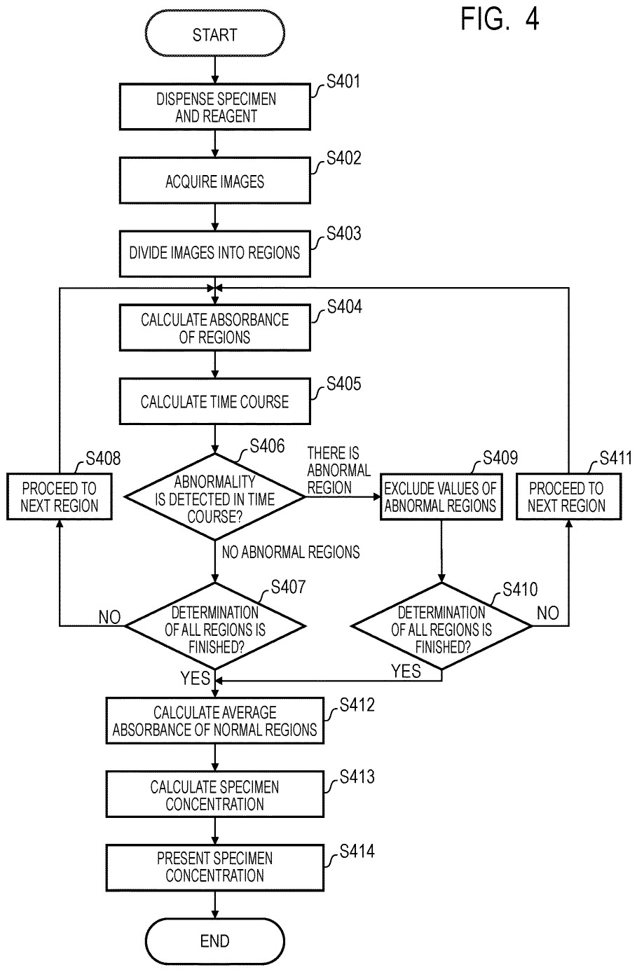

Next, a specimen testing method according to the first embodiment executed in the above-mentioned specimen testing device 100 is described with reference to a flowchart of FIG. 4. FIG. 4 is a flowchart of processing for measuring a specimen concentration based on absorbance executed on the cell array 101. When the cell array 101 is set in a dispensing device (not shown), testing is started, and the device control unit 120 advances the processing flow to Step S401.

In Step S401, a specimen and reagent dispensing device (not shown) dispenses a specimen and a reagent into each cell of the cell array 101. After dispensing, publicly-known predetermined processing such as stirring is performed, and after a predetermined time has elapsed, the cell array 101 is conveyed by the conveying device 102 to a testing position in the photometry unit 103. When the cell array 101 reaches the predetermined testing position, the device control unit 120 advances the processing flow to Step S402.

In Step S402, light from, for example, the above-mentioned LED 105a is applied onto the cell array 101, and the images 201a to 201e of the light transmitted through the specimens 101a to 101d and the water 101e are picked up by the monochrome camera 104. This image pickup is performed a plurality of times at predetermined time intervals. In practice, similar images are picked up by changing the LED that emits light. However, the subsequently executed processing is the same for the images acquired using the other LEDs as for the image acquired using the LED 105a, and hence only the processing for the image acquired using the LED 105a is described below. The image acquisition unit 121 acquires an image picked up by the monochrome camera 104. After the image is acquired, the device control unit 120 advances the processing flow to Step S403.

In Step S403, the images 201a to 201e obtained by picking up an image of each cell with the monochrome camera 104 are each divided into 10×10 regions, that is, 100 regions, by the region dividing unit 122, as illustrated as an example in FIG. 2. The number of divisions is an example, and can be changed as appropriate depending on the size of the specimen, the number of pixels of the monochrome camera, and the like. After the image is divided, the device control unit 120 advances the processing flow to Step S404.

In Step S404, the determination unit 123 calculates the absorbance of each divided region. In this embodiment, the absorbance is calculated by averaging the pixel values of the pixels contained in each region, and the calculated value is represented by Iave. The average of the pixel values of the water in the image is represented by I0. In this case, an absorbance is expressed by the following expression.

In=−log(Iave_n/I0) (1)

In the expression, “n” is the address of the divided region. In this embodiment, the image is divided into 100 regions, and hence a numerical value of from 1 to 100 is assigned. The determination unit 123 calculates the absorbance of all 100 regions from images obtained at a plurality of timings with a predetermined time interval therebetween. After the absorbance calculation is complete, the determination unit 123 advances the processing flow to Step S405.

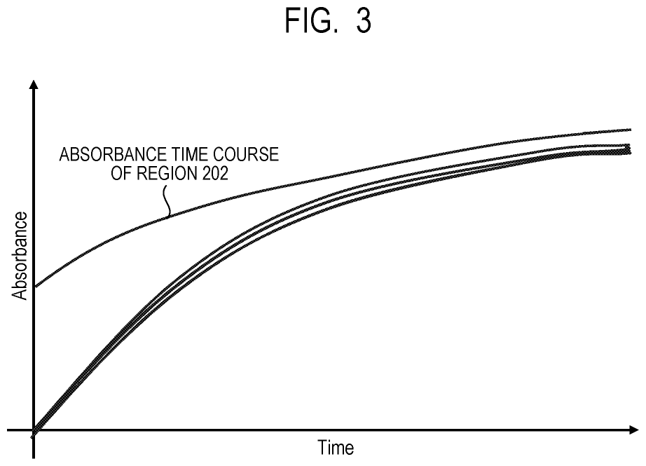

In Step S405, the determination unit 123 calculates the time course of the absorbance of each region, and in the following Step S406, the calculated time course for each region is compared. FIG. 3 is a graph for showing an example of the calculated time course for each region. The term “time course” as used herein corresponds to a temporal change in the pixel value of the pixels contained in each region, and in this embodiment, this temporal change is referred to as “time course” that corresponds to a temporal change in absorbance. There is no comparison target for the first time course, and thus in this case, a time course relating to a similar specimen stored in the storage unit 130 may be used for comparison, or after a certain number of time courses have been obtained, the average of those time courses may be used for comparison. The information acquired by the determination unit 123 based on the time course in Step S405 is information relating to whether or not there are pixels indicating an abnormality in the divided regions. In other words, the information acquired by the determination unit 123 is information on an abnormality in the pixel values, for example, the presence of a pixel value indicating an abnormality, the presence of a (normal) pixel value indicating no abnormality, and the presence of both of a pixel value indicating an abnormality and a pixel value indicating no abnormality. The determination unit 123 can execute the determination processing of Step S406 based on the presence or absence of pixels (for example, region 202 in FIG. 2) to which information on an abnormality in those pixel values has been assigned. When no abnormality is found in the time course, the determination unit 123 advances the processing flow to Step S407, and the time course for the next region is compared by executing Step S407 and Step S408. Another way of saying “no abnormality is found in the time course” can be “the time course is found to be normal.”

When there is no significant difference in the absorbance time course of each region, the determination unit 123 determines that the specimen is uniform and does not contain an abnormal region. The information acquisition unit 124 acquires abnormality-related information indicating that all regions are normal (no abnormalities are observed in any region) from the determination unit 123. Based on the acquired abnormality-related information, the information acquisition unit 124 advances the processing flow to Step S412 based on the premise that all pixel values of the 100 regions are to be used. In this case, in Step S412, the calculation unit 125 calculates the average value of the entire cell from the average value of the calculated pixel values, and calculates that average value as the time course of the absorbance of that cell.

However, as shown in FIG. 3, there are cases in which the time course for a certain region (region 202 in FIG. 2) differs significantly from the time course for another region (for example, the slope of the time course differs by a factor of two or more). Conceivable examples of abnormalities include the presence of something in the cell that blocks transmitted light, such as foreign matter contaminating the specimen or an air bubble being introduced during dispensing/mixing.

When it is determined that the time course is significantly different, the determination unit 123 determines that some kind of abnormality has occurred in that region, and transmits that information to the information acquisition unit 124. When the information acquisition unit 124 receives information that there is a region indicating an abnormal value in the time course, the information acquisition unit 124 excludes the pixel values of that region in Step S409, and the next time course is compared by executing Step S410 and Step S411.

Here, when information indicating an abnormality has been obtained, after Step S409, the next time course is immediately compared by executing Step S410 and Step S411. However, after Step S409, the information acquisition unit 124 may notify the display control unit 128 that information on an abnormality has been obtained, and the display control unit 128 may display information indicating the fact on the display 113. Further, after the display, the subsequent processing flow may be executed without interruption, or the processing flow may be immediately ended and display for prompting the user to perform retesting may be performed. After the determination of all regions ends, the information acquisition unit 124 selects the region to be used for calculating an absorbance in the next Step S412 based on the information on the abnormality, and advances the processing flow to Step S412.

In Step S412, regions determined to have an abnormality are excluded from all the regions, and the average value of the pixel values of all of the remaining regions is calculated from the average value of the pixel values of the remaining regions. The time course of the absorbance of the cell is then recalculated from that average value, and the recalculated time course is used as the absorbance time course of the specimen. Once the time course has been calculated, the device control unit 120 advances the processing flow to Step S413. Finally, the concentration of the substance to be detected in the specimen is calculated from the calculated time course, and the display control unit 128 presents the calculation result on, for example, the display 113 (Step S414).

In this way, with the specimen being imaged as a transmission image, the obtained transmission image being divided into a plurality of regions, and the absorbance of each region being calculated, it is possible to detect foreign matter in the specimen. Through enabling foreign matter to be detected, even for specimens that, in related-art methods, have been deemed abnormal and sent for retesting, an absorbance can be recalculated by excluding regions containing foreign matter. As a result, it becomes possible to further improve testing throughput.

In this embodiment, the exposure time is adjusted for each LED to maximize the pixel values, but the present disclosure is not limited thereto. For example, the light emission state of each LED may be changed so that the maximum pixel value of the picked-up image is slightly below the saturation condition of the camera. However, in order to measure minute changes in absorbance, it is desired to change, for example, the brightness or exposure time of the LEDs, or the gain setting of the camera so as to use as much of the dynamic range of the camera as possible.

### Second Embodiment

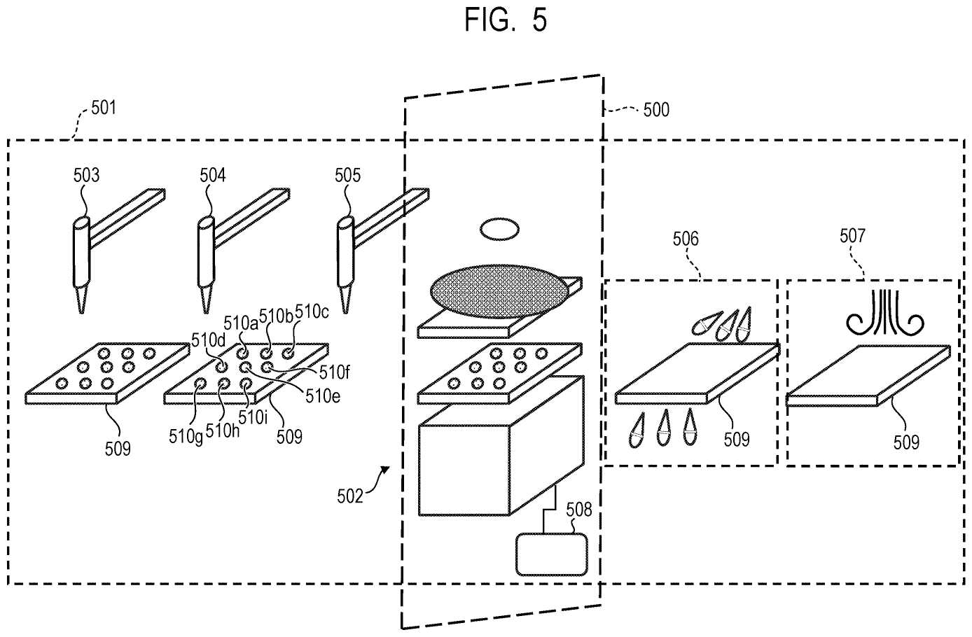

Next, a second embodiment of the present disclosure is described with reference to FIG. 5 to FIG. 9. FIG. 5 is a diagram for schematically illustrating an overall configuration of a specimen testing system including one example of a specimen testing device according to the second embodiment.

A specimen testing system 501 illustrated in FIG. 5 includes a specimen dispensing unit, a reagent dispensing unit, a specimen testing device 500, a cleaning unit 506, and a drying unit 507. The specimen dispensing unit includes a specimen dispenser 503, and the specimen dispenser 503 dispenses specimens onto a specimen plate 509. In this embodiment, the reagent dispensing unit includes a first reagent dispenser 504 and a second reagent dispenser 505, and is capable of dispensing two types of reagents to specimens 510a to 510h dispensed onto the specimen plate 509. The cleaning unit 506 cleans the specimens on the specimen plate 509 after testing, and the drying unit 507 dries the cleaned specimen plate 509 to prepare the specimen plate for use in subsequent testing. The specimen testing device 500 includes a photometry unit 502, like in the first embodiment, and each component of the photometry unit 502 is controlled by a device control unit 508. Details of the photometry unit 502 are described later.

An example of the testing step in the specimen testing system 501 is now described. The specimens placed in the specimen testing system 501 are stored in a sample repository (not shown) and dispensed onto the specimen plate 509 by the specimen dispenser 503. At this time, the plurality of specimens 510a to 510h are arranged in droplets on the specimen plate 509, and are lined up two-dimensionally. After the specimens 510a to 510h have been dispensed, a first reagent is taken out from a reagent repository (not shown), and the first reagent is dispensed to and mixed with the specimens 510a to 510h by the first reagent dispenser 504. After the first reagent has been dispensed, the specimens 510a to 510h are conveyed to the photometry unit 502, and a two-dimensional image of the transmitted light is picked up by a monochrome camera 605 described later.

In this embodiment, image pickup is performed a plurality of times during mixing of the dispensed specimen and reagent. Specifically, after image pickup is performed after the first reagent is dispensed, a second reagent is taken out from a reagent repository (not shown), and the second reagent is dispensed to the specimens 510a to 510h by the second reagent dispenser 505. Under a state in which the second reagent is dispensed, the specimens 510a to 510h on the specimen plate 509 are again guided to the photometry unit 502, and a two-dimensional image of the transmitted light is picked up. During the period for which the second reagent is reacting, the specimen plate 509 passes through the photometry unit 502 a plurality of times, and image pickup is performed the same number of times as the number of passes. After sufficient images have been picked up after the second reagent has been dispensed, the specimen plate 509 is moved to the cleaning unit 506, and then the specimen plate 509 is cleaned. The specimen plate 509 is then dried in the drying unit 507, and the specimens are then dispensed onto the specimen plate 509 again by the specimen dispensing unit.

In this embodiment, the specimens 510a to 510h are arranged two-dimensionally on the specimen plate 509 and are picked up as a two-dimensional image. At this time, a mixture of the specimen, the first reagent, and the second reagent is arranged in the specimens 510a to 510h, but water is dispensed at the position of the specimen 510i on the specimen plate 509. This water is used as a reference of the pixel values during two-dimensional image pickup. In this embodiment, the water dispensing position is set at the very edge, but the position is not limited thereto, and may be set near the center. Further, the position is not required to be fixed, and for example, the position at which water is dispensed may be recorded for each specimen plate, and the calculation may be performed by linking that position to the picked-up image to identify the position of the water that serves as the reference for calculation.

There are many types of reagents used for specimens, some of which measure an absorbance in the ultraviolet region. However, typical image pickup lenses have very low transmittance in the ultraviolet region, and are unsuitable for image pickup. It is required to use a lens having high transmittance in the ultraviolet region. Further, some types of reagents require measurement in the near-infrared region, but lenses having high transmittance in the ultraviolet region often cause a large shift in the focus position in the near-infrared region. For this reason, in a case of using a UV-compatible lens, it is often required to refocus (execute focus correction) or prepare a separate optical system at the time of performing image pickup in the near-infrared region. The former requires time for focus correction, which reduces the specimen testing throughput, while the latter requires additional costs.

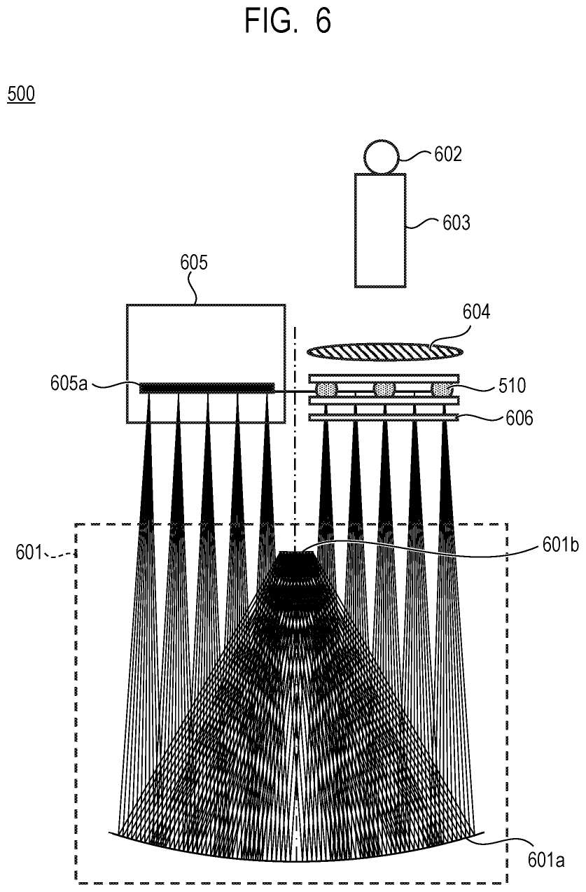

Accordingly, in this embodiment, a reflective optical system 601 is used as illustrated in FIG. 6 to solve this issue. FIG. 6 is a schematic diagram for illustrating an overall configuration of the specimen testing device 500 according to this embodiment. The specimen testing device 500 according to this embodiment includes a reflective optical system 601, a light source 602, a rod lens 603, an illumination optical system 604, a monochrome camera 605, and a wavelength filter 606.

In this embodiment, the reflective optical system 601 includes two aspherical mirrors (a concave mirror 601a and a convex mirror 601b), and functions as an image capturing optical system. The image capturing optical system forms a transmission image of the specimen on an image sensor 605a in the monochrome camera 605. An image capturing optical system configured as described above is characterized by having no focus fluctuation ranging from ultraviolet light (wavelength of 340 nm) to near-infrared light (wavelength of 810 nm), and having very high transmittance (approximately 70%). However, the configuration of the image capturing optical system is not limited to this example, and a transmissive optical system or other optical system may be used as long as the required transmittance is maintained ranging from ultraviolet light to near-infrared light and focus shift is small.

A white light source can be used as the light source 602 in order to enable image pickup by using light ranging from ultraviolet light to near-infrared light. The rod lens 603 and the illumination optical system 604 are arranged in order to convert the white light emitted from the light source 602 into light having a wide and uniform illumination range. In this way, the light beam from the light source 602 is converted into uniform illumination by using the rod lens 603 and the illumination optical system 604, and applied onto the specimen 510.

Examples of light sources that can be used as the light source 602 include a halogen lamp, a laser-excited plasma light source, and a white LED. Light emitted by the light source 602 and transmitted through the specimen is picked up by the monochrome camera 605. In this embodiment, during image pickup, in order to select the wavelength required for a specific reagent, the wavelength filter 606 is inserted in the optical path and the image is picked up. Using the wavelength filter 606 in this way enables an image to be picked up by using light having a specific wavelength.

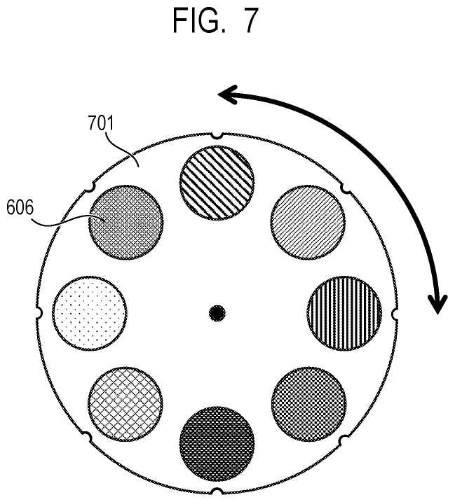

In this case, it is preferred to prepare wavelength filters in a number corresponding to the number of wavelengths required and to switch the wavelength filter as required. In this embodiment, image pickup is performed while switching filters by rotating a filter turret 701 as illustrated in, for example, FIG. 7. In FIG. 7, a schematic configuration of the filter turret 701 which has a plurality of wavelength filters 606 and which can be rotated to position an appropriate wavelength filter 606 in the optical path of the light used for image pickup is illustrated. At the time of changing the wavelength filter 606, it is preferred to change the exposure time for image pickup to match the intensity of each wavelength of light used for image pickup. Through appropriately changing the exposure time, it becomes possible to always pick up images in a manner that fully utilizes the dynamic range of the monochrome camera 605.

The method of picking up an image of the transmitted light is not limited to the method taken as an example as the second embodiment, and for example, such a filter that stabilizes the intensity of the transmitted light may be inserted after the white light source 602. The position of the filter which limits the wavelength of the picked-up image is also not limited to the position illustrated as an example in FIG. 6, and the filter may be arranged immediately in front of the monochrome camera 605. In FIG. 7, the example in which the filter turret 701 has eight filters is illustrated, but the number of filters may be four or 16 instead of eight. Further, instead of using only one filter turret 701, a plurality of filter turrets 701 may be used to increase the number of wavelengths that can be handled by the filters.

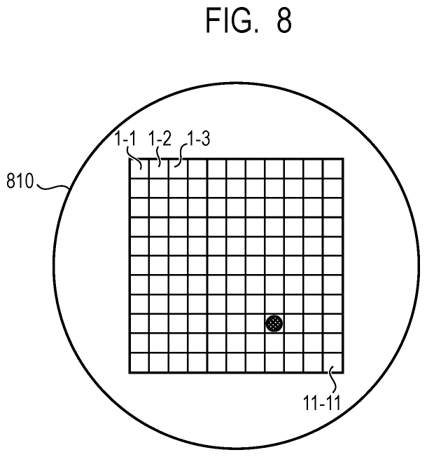

In this embodiment, the imaged specimens 510a to 510h are divided into 11×11 regions within each image, and the pixel values of the pixels contained in each region are averaged. The steps from image acquisition to presenting the specimen concentration are the same as in the first embodiment described with reference to FIG. 4. An example of the division of an image 810 of one specimen 510a in this embodiment is illustrated in FIG. 8. During division, the periphery of the specimen image 810 appears dark, and hence the image may be divided into regions so as not to include that dark portion. For example, it is desired that the edges of the divided regions fall within 80% of the diameter of the substantially circular specimen image. More specifically, it is desired that the edges of the divided regions fall within 60%. Each region obtained after division in the image 810 is assigned an address, such as 1-1, 1-2, . . . from the top left, and an address such as 11-11 from the bottom right.

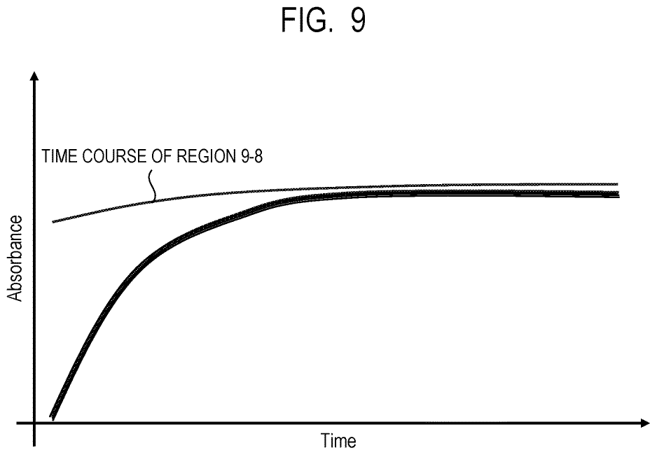

In order to obtain the time course, each of the specimens 510a to 510h is imaged a plurality of times, and the average value of the pixel values of each region is calculated each time. Plotting the average value of the pixel values of each region against the temporal change reveals how the brightness of the transmission image of each of the specimens 510a to 510h decreases. An absorbance is calculated from this change in the pixel values and the pixel values of the transmission image of water, and the calculation results are graphed as the time course of the absorbance. FIG. 9 is a graph for showing the obtained time courses. When attention is paid to the rate of change (slope) of the absorbance, it can be seen that only in a region 9-8, the slope of the absorbance time course is very small. In this embodiment, regions exhibiting such a difference in a change are picked out, and those regions are determined to be abnormal regions, and are excluded. Then, the pixel values of the remaining regions are averaged again. The time course of the absorbance of the specimen is obtained from the average pixel value of the regions that have not been excluded and have been determined to be normal, and the obtained time course is presented.

The criteria for determining whether or not an abnormal value is indicated can be based on a slope abnormality, such as whether or not the slope of the time course differs by a factor of three or more. However, abnormality determination is not limited thereto, and another method may be used. For example, a region may be determined to be abnormal when the pixel values of that region differ by 30% or more from the average pixel value of the 121 regions. After the time course is calculated by excluding the regions indicating an abnormal value, the concentration of each component is calculated from the detected time course, and the test result is output as the final test value.

In this embodiment, with the time course being calculated while eliminating abnormal values, it becomes possible to accurately measure the time course, and it is no longer required to remeasure the specimen, and hence throughput can be improved. Further, with remeasurement being no longer required, the amount of reagent used is reduced, which also leads to cost reduction.

The specimens 510a to 510h for which an absorbance has been measured are finally sent to the cleaning unit 506, and all the specimens are washed away. The remaining specimen plate 509 is then dried in the drying unit 507 and sent to a waiting unit (not shown). When new specimens are inserted into the specimen testing system 501, the specimens are again dispensed onto the specimen plate 509, and used for measurement. Although the specimen plate 509 is cleaned in this embodiment, the present disclosure is not limited thereto, and the specimen plate may be disposed of as a disposable plate without being cleaned.

As described above, in this embodiment, the method of obtaining the time course by dividing each of the images of the imaged specimens 510a to 510h is performed on all specimens (510a to 510h) on the specimen plate. As a result, foreign matter detection can be performed on all eight specimens. Through detecting foreign matter and performing measurement by excluding, when there is foreign matter, the regions containing the foreign matter while processing eight specimens simultaneously, it becomes possible to improve throughput while still achieving accurate specimen processing.

### Third Embodiment

In addition to the contamination by foreign matter such as an air bubble described above as an example, abnormalities that may arise during specimen imaging may also be caused by insufficient stirring. In a third embodiment, when insufficient stirring is detected immediately after reagent dispensing from the image of the imaged specimen, and a determination of insufficient stirring is made, this determination of insufficient stirring is acquired and reported as information on an abnormality. When insufficient stirring is acquired as information on an abnormality, an accurate absorbance can be calculated by restirring the specimen. The processing flow other than the method of detecting insufficient stirring and the procedure for restirring is the same as in the first embodiment. Moreover, the configuration of the specimen testing device to be used is the same as in the first embodiment or second embodiment, and hence description of the configuration of the specimen testing device is omitted in this embodiment. In addition, in the description of this embodiment, components having the same reference numerals as in the other embodiments have the same function.

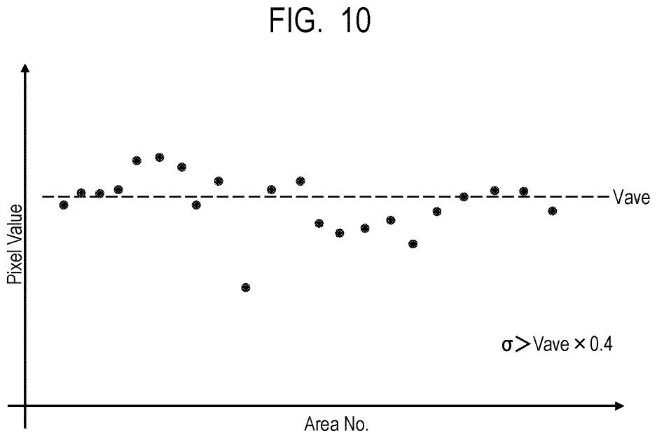

In this embodiment, as in the first embodiment, the images 201a to 201d of each cell in the transmission image of the imaged cell array 101 are divided into 100 regions (10×10). Next, for each of the 100 regions, the average pixel value of the pixels contained in the region is obtained. The average pixel values of the respective regions are represented by V1 to V100. In FIG. 10, some of the obtained average pixel values are shown on a graph.

Then, a variance σ of the average of the 100 pixel values is calculated. Here, when the average of V1 to V100 is represented by Vave, and the previously calculated σ satisfies:

Σ>Vave×0.4 (2),

it is assumed that concentration unevenness has occurred due to insufficient stirring, and the cell array corresponding to the image containing that region is restirred. This eliminates specimen concentration unevenness due to insufficient stirring, and enables an accurate absorbance time course to be obtained. In addition, with the expression (2) being further modified to the following expression (3):

σ>Vave×0.25 (3),

insufficient stirring can be detected in more detail, which enables stirring to be repeated to measure the accurate absorbance.

The calculation of the average value of the pixel values of each region, the calculation of variance, and the determination of the presence or absence of concentration unevenness are executed by the determination unit 123. In the third embodiment, only detection of insufficient stirring has been described, but the application of the present disclosure is not limited thereto, and it is possible to combine the detection of insufficient stirring with, for example, the detection of foreign matter in the first embodiment. In this case, the third embodiment is executed first to detect insufficient stirring. Then, after restirring, the foreign matter detection described in the first embodiment is executed. Those abnormality-related determination processes by the determination unit 123 enable the determination unit 123 to acquire information on the cause of the pixel values indicating an abnormality. Through executing each embodiment in such an order, after sufficient stirring, foreign matter can be detected and the time course can also be calculated.

In the first to third embodiments, insufficient peripheral light caused by the image pickup system used for image pickup is not described, but it is desired to correct unevenness in brightness in the image pickup system caused by insufficient peripheral light. For example, in the case of the third embodiment, before the specimen is imaged, image pickup may be performed under a state in which a cell is not arranged, to acquire a white image which serves as a background, and the unevenness in that brightness may be measured. In this case, after a cell array is actually arranged and image pickup is performed, the unevenness in brightness caused by the image pickup system is corrected first by dividing the pixel values by the reciprocal of the brightness of the background, which enables only the influence of insufficient stirring of the specimen and foreign matter in the specimen to be acquired.

As described above, the specimen testing method according to one aspect of the present disclosure includes a step of imaging the specimens 101a to 101d (Step S402) and a step of dividing the images 202a to 202e of the specimens into a plurality of regions (Step S403). The imaging step may be executed by a camera, such as a monochrome camera (104, 605). In this embodiment, the dividing step may be executed by, for example, the region dividing unit 122 included in the device control unit 120. The specimen testing method includes a step in which, for example, the determination unit 123 creates a time course for each region based on the pixel values of the divided regions, compares the created time courses, and the information acquisition unit 124 included in the device control unit 120 acquires information on an abnormality in the pixel values of the divided regions. That is, the specimen testing device 100 according to one aspect of the present disclosure includes the camera, the region dividing unit 122, and the information acquisition unit 124. In the above-mentioned embodiments, time courses are used to determine whether or not the pixel values are abnormal. However, another publicly-known method can be used as the determination method as long as it is possible to identify, by using the pixel values of each region, the pixel values that are problematic in detecting the test value due to, for example, foreign matter or insufficient stirring, contained in the specimen, from the pixel values of other regions.

This specimen testing method further includes a step in which the calculation unit 125 calculates the test value of the specimen based on the information on an abnormality in the pixel values (Step S413). At this time, the information acquisition unit 124 acquires the information on an abnormality in the pixel values, and based on the acquired information, determines the divided regions having the pixel values to be used in the step (Step S413) of calculating the test value. In terms of the above-mentioned first embodiment, it is determined that the pixel values of the regions other than the divided region 202 in the image 201a of the specimen are to be used to calculate the test value. In this case, the determination unit 123 functions as a region determining unit to determine the pixel values of the regions that are to be used to calculate the test value.

In this case, the determination unit 123 obtains the information on an abnormality by comparing a temporal change in the pixel values of the pixels contained in each of the plurality of regions, among the plurality of regions. Specifically, in the first and second embodiments described above, the information on an abnormality is obtained by comparing the time course of each region. Then, the information acquisition unit 124 acquires, as the information on an abnormality, information on a region having a temporal change which differs from the temporal changes of the other regions included in the plurality of regions by a predetermined difference or more. The information acquisition unit 124 then determines that the regions other than the region having a difference among the plurality of regions are the divided regions having the pixel values to be used in the step of calculating the test value. In the step of calculating the test value of the specimen in the first and second embodiments described above, the calculation unit 125 calculates the test value based on the average of the test values included in the determined divided regions. However, the method of calculating the test value is not limited to using the average value, and various publicly-known methods of obtaining a representative value from a plurality of values can be used. Further, the information acquisition unit 124 can also function as a region determination unit which determines, based on the information on an abnormality in the pixel values, whether or not the pixel values of each divided region are to be used in testing (Step S406, Step S407, Step S409, and Step S410).

The information on an abnormality in the pixel values described above includes information on the pixel values indicating an abnormality, information on the pixel values indicating no abnormality, and a determination result regarding the information on the pixel values indicating an abnormality and the pixel values indicating no abnormality. The determination by the information acquisition unit 124 functioning as a region determination unit as to whether or not the pixel values of the divided regions are to be used for testing is executed based on whether or not information on the pixel values indicating an abnormality is assigned to the pixels contained in those divided regions. The information on an abnormality may include information on a cause of the pixel values indicating an abnormal value. In this case, the information on the cause of the pixel values indicating an abnormal value may include any one of the information indicating that the specimen contains foreign matter described as an example in the first and second embodiments or the information indicating insufficient stirring of the specimen described as an example in the third embodiment. However, the information on the cause for indicating an abnormal value is not limited to those examples, and may include any cause that can be distinguished or assumed from an image of the specimen by using transmitted light. In the case described in the third embodiment, the information indicating insufficient stirring is information on whether or not the average Iave and the variance σ of the pixel values of the pixels contained in each region satisfy σ>0.4×Iave.

The above-mentioned specimen testing device 100 can notify the operator of an abnormality in the specimen based on the information on an abnormality in the pixel values by using a notification unit including, for example, the display control unit 128 and the display 113. Further, as described in the second embodiment, the specimen testing device 500 may include a filter (606) that transmits light having a wavelength that matches the reagent to be mixed with the specimen, and a transmission image of the specimen at a wavelength corresponding to the reagent may be picked up through the filter. Further, in the first to third embodiments described above, the absorbance of the specimen is determined as the test value, but the test value for obtaining the characteristics of the specimen is not limited to an absorbance. In addition, in consideration of simplifying processing and improving the testing accuracy, it is desired to further image the water (101e) to be used for zero correction at the time of calculating the absorbance of the specimen in the imaging step.

The specimen testing device 100 described in the first embodiment can further include a light source device (light source 105) including light sources (LEDs 105a to 105d) of a plurality of wavelengths. In this case, the light source device (light source 105) can cause the light source having the wavelength corresponding to the reagent to be mixed with the specimen to emit light. The monochrome camera 104 picks up a transmission image of the specimen by using light having the wavelength corresponding to the reagent. Then, the calculation unit 125 calculates the test value of the specimen based on the transmission image. The specimen testing device 500 described in the second embodiment can further include a light source device including the light source 602 having an emission wavelength ranging from ultraviolet to near-infrared, and a filter (wavelength filter 606) inserted between the light source device and the monochrome camera 605. The filter which is used is a filter that transmits light having a wavelength that matches the reagent to be mixed with the specimen. In this case, the monochrome camera 605 picks up a transmission image of the specimen by using light having the wavelength corresponding to the reagent. In the second embodiment, the monochrome camera 605 includes the image sensor 605a, and the specimen testing device 500 includes the image capturing optical system (reflective optical system 601) that forms a transmission image of the specimen on the image sensor. In the second embodiment, the image capturing optical system includes two reflective surfaces (601a, 601b). One of the reflective surfaces may be a concave mirror (601a) and another one of the reflective surfaces may be a convex mirror (601b).

Further, the specimen testing device according to one aspect of the present disclosure may include a camera (104), the device control unit 120 including the region dividing unit 122, the determination unit 123, and the calculation unit 125, and a notification unit (128, 113). In this case, the monochrome camera 104 functions as a camera that images the specimen. The region dividing unit 122 divides the specimen image into a plurality of regions. The determination unit 123 determines whether or not the average Iave and the variance σ of the pixel values of the pixels contained in the divided regions satisfy σ>0.4×Iave, and in such a case, determines that the specimen has not been sufficiently stirred. The notification unit notifies the operator of the insufficient stirring determined by the determination unit.

In related-art specimen measurements, when a specimen contains foreign matter or the like or when there is insufficient stirring, it is required to remeasure the specimen or to measure a new specimen. In this case, the entire specimen array is remeasured, which means that all the specimens are moved to the remeasurement location, which may significantly reduce the throughput of the device. In one aspect of the present disclosure, the specimen is imaged, the image is divided into regions, and, for example, an absorbance is calculated as a test value for each region. Through this process, with the present disclosure, it is possible to detect foreign matter contamination or bubble contamination in the specimen. Further, with regions containing foreign matter being excluded, an absorbance can be measured without remeasuring the specimen, thereby enabling specimen measurement without reducing the throughput of the device.

### Fourth Embodiment

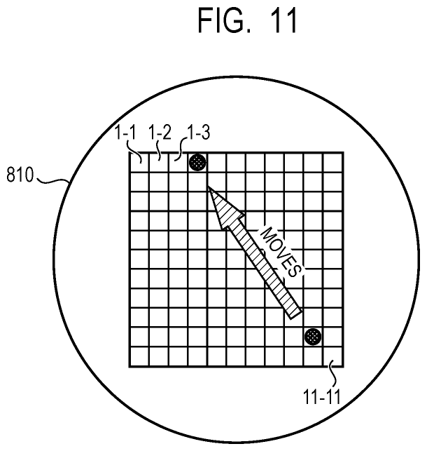

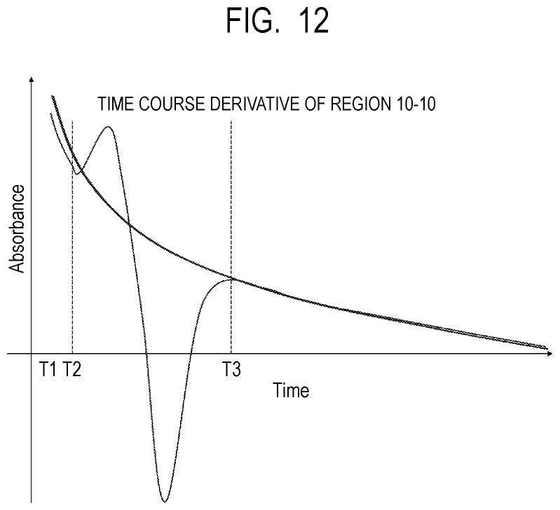

Next, a fourth embodiment of the present disclosure is described with reference to FIG. 11 and FIG. 12.

In this embodiment, the method of detecting the abnormal value that is used in the second embodiment is modified. In the second embodiment, a method in which continuously acquired image data is divided into regions, the absorbance of each divided region is calculated, and abnormal regions are detected based on a difference in the slope of a temporal change graph of the absorbance is described.

In contrast, in this embodiment, a pixel value change (time course) of each region is determined from the temporal change of the slope of the pixel value change (second derivative of the time course), and abnormalities are detected by checking for a sudden change in the second derivative. For example, as illustrated in FIG. 11, when a piece of foreign matter in an area 10-10 moves during measurement to an area 1-4, in this case, the time course acquired in, for example, an area 9-9 shows a sudden increase in absorbance at a time point when the piece of moving foreign matter enters the area (between T2 and T3), and then returns to the original absorbance, as shown in FIG. 12. To detect this, the second derivative of the time course is calculated. When the second derivative is acquired, a time period during which the second derivative value of the absorbance fluctuates significantly as in FIG. 12 is detected. When there is a change of, for example, twice or more the second derivative value between previous and next time points, the absorbance for that time period is excluded from the calculation. Similarly, for other areas, when there is a sudden change, the absorbance of the relevant area and the time period is excluded, and the average value for the other areas is used. As a result, when a sudden change occurs in the time course, abnormal values can be eliminated and the correct time course can be calculated by excluding the absorbance at that time, calculating the average value from the absorbance of the other areas, and recalculating the time course.

### Fifth Embodiment

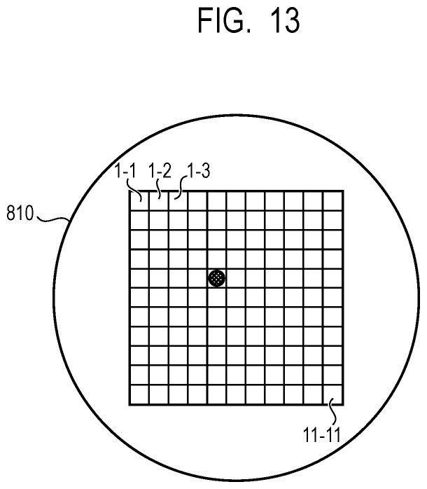

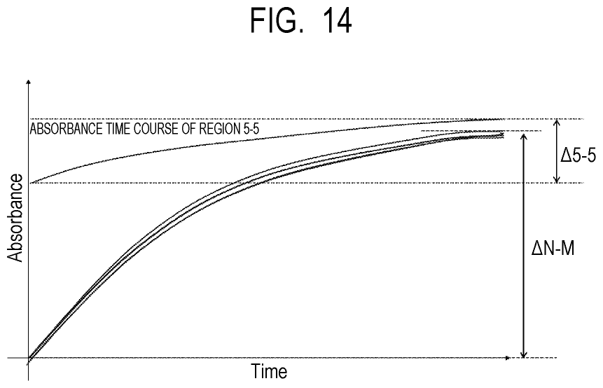

Next, a fifth embodiment of the present disclosure is described with reference to FIG. 13 and FIG. 14.

In this embodiment, the following method is described. Specifically, the pixel values of each region are checked regarding a difference in the pixel values between a time period soon after dispensing the reagent (for example, one minute later) and a time when the reaction has sufficiently progressed (endpoint: several minutes later). When the difference in pixel values falls within a certain range, an abnormal value is not determined to exist, but when the difference in pixel values falls outside that range, the region is determined to contain an abnormality, and an endpoint is calculated by using the pixel values of the regions other than that region.

When there is foreign matter contamination as in FIG. 13, the temporal fluctuation in absorbance of an area 5-5 behaves differently from that of the other areas, as shown in FIG. 14, and the final value of the absorbance tends to be higher. In the case of a reagent that uses an endpoint method, the determination is performed based only on the final value, and hence the numerical value of the area 5-5 may be determined to have a very high concentration. Accordingly, the difference in pixel values of each area between the initial state and the final state is compared. For the initial pixel value, the absorbance is very low because the specimen is almost transparent, and the difference in absorbance with the final state can be calculated. When an abnormality occurs as in the area 5-5 of FIG. 13, the difference between the initial value and the final state (Δ5-5 of FIG. 14) is also small, and a clear difference can be obtained from the numerical values of the other areas (ΔN-M). When this difference is large or small compared to the values of the other areas, an abnormality can be determined to have occurred. Specifically, for example, when the difference value of the area 5-5 of FIG. 13 is significantly different from that of other areas, such as three times or one-third of the value, the value can be determined to be abnormal. This difference also depends on, for example, the reagent, and hence it is desired to set a threshold value for each reagent in advance.

As described above, by continuously acquiring the pixel values of the divided regions of the specimen image for a certain period of time, it becomes possible to exclude regions containing an abnormality based on the temporal fluctuations in the pixel values. Conceivable examples of temporal fluctuations include the slope of the temporal change in absorbance, the derivative of the slope, and the final pixel value. Through acquiring the abnormal values based on such temporal fluctuations, it becomes possible to perform calculations while omitting the pixel values of the regions corresponding to an abnormal value, and determine a correct temporal change.

Further, it goes without saying that the present disclosure is achieved by the following. That is, the present disclosure can also be implemented through processing of supplying a program that implements one or more functions of the above-mentioned embodiments to a system or a device via a network or a storage medium, and reading out and executing the program by one or more processors in a computer of the system or the device. Moreover, the present disclosure can also be implemented by a circuit (for example, an ASIC) that implements the one or more functions. Moreover, various recording media such as a flexible disk, an optical disc (for example, CD-ROM and DVD-ROM), a magneto-optical disc, a magnetic tape, a nonvolatile memory (for example, USB memory), and a ROM can be used as the storage medium. Moreover, a program that implements the above-mentioned functions may be downloaded via a network, and may then be executed by a computer.

Moreover, the implementation of the functions in the above-mentioned embodiments is not limited to the computer executing the read-out program code. A case in which an operating system (OS) running on a computer, or the like executes a part or the whole of actual processing based on an instruction of this program code and the functions of the above-mentioned embodiments are implemented by this processing is also included.

Further, the program code read out from the recording medium may be written to a memory provided to a function extension board inserted into the computer or a function extension unit connected to the computer. A case in which a CPU or the like provided to the function extension board or the function extension unit executes a part or the whole of the actual processing based on the instruction of this program code and the above-mentioned functions are implemented by this processing is also included.

According to one aspect of the present disclosure, an abnormality in a specimen can be suitably detected in a specimen test.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-058642, filed Mar. 31, 2025, and Japanese Patent Application No. 2026-040217, filed Mar. 12, 2026, which are hereby incorporated by reference herein in their entirety.

What is claimed is

1. A specimen testing method comprising:
imaging a specimen;
dividing an image of the specimen into a plurality of regions; and
acquiring, based on pixel values of the plurality of divided regions, information on an abnormality in the pixel values of the plurality of divided regions,
wherein the information on the abnormality in the pixel values is acquired based on a change in the pixel values acquired at different times.

2. The specimen testing method according to claim 1, further comprising calculating a test value of the specimen based on the information on the abnormality in the pixel values.

3. The specimen testing method according to claim 2, further comprising determining, based on the information on the abnormality in the pixel values, divided regions that have the pixel values to be used in the calculating of the test value.

4. The specimen testing method according to claim 3,
wherein the information on the abnormality is obtained by comparing a temporal change in the pixel values of pixels included in each of the plurality of regions among the plurality of regions, and is information on a region in which the temporal change has a difference of a predetermined difference or more from temporal changes of other regions included in the plurality of regions, and
wherein the specimen testing method further comprises determining, as the divided regions that have the pixel values to be used in the calculating of the test value, a region other than the region in which the temporal change has the difference of the predetermined difference or more among the plurality of regions.

5. The specimen testing method according to claim 1, further comprising determining whether the pixel values of the plurality of divided regions are to be used in a test based on the information on the abnormality in the pixel values.

6. The specimen testing method according to claim 5,
wherein the information on the abnormality in the pixel values includes information on pixel values indicating an abnormality, information on pixel values indicating no abnormality, and a determination result relating to information on the pixel values indicating an abnormality and the pixel values indicating no abnormality, and
wherein whether the pixel values of the plurality of divided regions are to be used in a test is determined based on whether or not the information on pixel values indicating an abnormality is assigned to pixels contained in the plurality of divided regions.

7. The specimen testing method according to claim 1, wherein the information on the abnormality includes information on a cause of the pixel values indicating an abnormal value.

8. The specimen testing method according to claim 7, wherein the information on the cause of the pixel values indicating an abnormal value includes any one of information indicating that the specimen contains foreign matter or information indicating insufficient stirring of the specimen.

9. The specimen testing method according to claim 1, further comprising notifying an operator of an abnormality in the specimen based on the information on the abnormality in the pixel values.

10. The specimen testing method according to claim 1, wherein the imaging includes picking up a transmission image of the specimen at a wavelength corresponding to a reagent to be mixed with the specimen through a filter configured to transmit light having a wavelength that matches the reagent.

11. The specimen testing method according to claim 2,
wherein the test value is an absorbance of the specimen, and
wherein the imaging includes further imaging water to be used for zero correction at the time of calculating the absorbance of the specimen.

12. A medium storing a program for causing, when executed by a computer, the computer to execute each step of the specimen testing method of claim 1.

13. A specimen testing device comprising:
a camera configured to image a plurality of specimens;
a region dividing unit configured to divide an image of each of the plurality of specimens into a plurality of regions; and
an information acquisition unit configured to acquire, based on pixel values of the plurality of divided regions, information on an abnormality in the pixel values of the plurality of divided regions.

14. The specimen testing device according to claim 13, further comprising a calculation unit configured to calculate a test value of the specimen based on the information on the abnormality in the pixel values.

15. The specimen testing device according to claim 14, further comprising a region determining unit configured to determine, based on the information on the abnormality in the pixel values, divided regions that have the pixel values to be used in the calculation of the test value by the calculation unit.

16. The specimen testing device according to claim 15,
wherein the information on the abnormality is obtained by comparing a temporal change in the pixel values of pixels included in each of the plurality of regions among the plurality of regions, and is information on a region in which the temporal change has a difference of a predetermined difference or more from temporal changes of other regions included in the plurality of regions, and
wherein the region determining unit is configured to determine, as the divided regions that have the pixel values to be used in the calculation of the test value by the calculation unit, a region other than the region in which the temporal change has the difference of the predetermined difference or more among the plurality of regions.

17. The specimen testing device according to claim 13, further comprising a region determination unit configured to determine whether the pixel values of the plurality of divided regions are to be used in a test based on the information on the abnormality in the pixel values.

18. The specimen testing device according to claim 13, further comprising a notification unit configured to notify an operator of an abnormality in the specimen based on the information on the abnormality in the pixel values.

19. The specimen testing device according to claim 14,
wherein the test value is an absorbance of the specimen, and
wherein the camera is configured to further image water to be used for zero correction at the time of calculating the absorbance of the specimen.

20. The specimen testing device according to claim 14, further comprising a light source device including light sources of a plurality of wavelengths,
wherein the light source device is configured to cause a light source having a wavelength corresponding to a reagent to be mixed with the specimen to emit light,
wherein the camera is configured to pick up a transmission image of the specimen by using light having the wavelength corresponding to the reagent, and
wherein the calculation unit is configured to calculate the test value of the specimen based on the transmission image.

21. The specimen testing device according to claim 14, further comprising:
a light source device including a light source having an emission wavelength ranging from ultraviolet to near-infrared; and
a filter which is to be inserted between the light source device and the camera, the filter being configured to transmit light having a wavelength that matches a reagent to be mixed with the specimen,
wherein the camera is configured to pick up a transmission image of the specimen by using light having the wavelength corresponding to the reagent, and
wherein the calculation unit is configured to calculate the test value of the specimen based on the transmission image.

22. The specimen testing device according to claim 21,
wherein the camera includes an image sensor,
wherein the specimen testing device further comprises an image capturing optical system configured to form a transmission image of the specimen on the image sensor, and
wherein the image capturing optical system includes two reflective surfaces.

23. A specimen testing device comprising:
a camera configured to image a specimen;
a control unit including:
a region dividing unit configured to divide an image of the specimen into a plurality of regions;
a calculation unit configured to calculate an average Iave and a variance σ of pixel values of pixels included in the plurality of divided regions; and
a determination unit configured to determine that the specimen has insufficient stirring when the variance σ satisfies σ>0.4×Iave; and
a notification unit configured to notify an operator of the insufficient stirring determined by the determination unit.
